(19) United States
(12) Patent Application Publication
(10) Pub. No.: US 2023/0416654 A1
(43) Pub. Date: Dec. 28, 2023

(54) Water-Based Cleaner for Removing Adhesives, Goo Substances, and Pine Sap

(71) Applicant: Dan Steinberg, Blacksburg, VA (US)

(72) Inventor: Dan Steinberg, Blacksburg, VA (US)

(21) Appl. No.: 18/215,820

(22) Filed: Jun. 28, 2023

Related U.S. Application Data
(60) Provisional application No. 63/356,048, filed on Jun. 28, 2022.

(51) Int. Cl. C11D 10/04; C11D 17/00; C11D 9/00; C11D 1/66; C11D 3/12

(52) U.S. Cl. CPC C11D 10/042; C11D 17/0013; C11D 9/002; C11D 1/662; C11D 3/124

(57) ABSTRACT

A water-based cleaner for removing adhesives and goo substances. The cleaner contains water, particles of a multi-valent metal fatty acid soap such as magnesium stearate or calcium stearate, and a surfactant that facilitates wetting of the soap particles. The soap has a low solubility in water, such as less than 100 mg/liter. Some of the soap particles may have an elongated shape with aspect ratios of 10 or more. The cleaner may also contain an abrasive material such as soda lime glass powder, limestone powder, or biodegradable polymer powder. To remove adhesive from a surface\, the cleaner is rubbed against a surface, for example with a scrubber. The present cleaner causes adhesive to detach from the surface, reattachment of the adhesive is prevented. The detached adhesive is then rinsed away with water.

### FIELD OF THE INVENTION

The invention relates to cleaning compositions and in particular to cleaners for removing substances such as acrylic adhesive, rubber adhesive, pine sap, and mastic adhesive.

### BACKGROUND OF THE INVENTION

Some “goo” substances are difficult or impossible to remove with conventional water-based surfactants and soaps such as sodium lauryl sulfate or sodium stearate. Examples of goo substances include acrylic adhesive, rubber adhesive, waterproof greases, pine sap and mastic adhesive.

Goo substances are typically removed and cleaned with solvent-based cleaners. Many solvent-based adhesive removers are available and they typically contain solvents such as D-limonene, naptha, glycol ether, petroleum distillates, isoparaffin, acetone, or xylene. Such solvent-based formulas are effective, but have many disadvantages. Most solvents are flammable and produce flammable vapors. Also, vapors released can be unpleasant, irritating or toxic.

Because solvents work by dissolving the goo, several applications are typically required to completely remove all traces of goo. If the solvent is volatile, it can evaporate during cleaning and leave a thin film of goo. Also, the solvent can “drop” the goo if water is used to rinse away the solvent (an approach that is effective sometimes).

Solvents typically penetrate the skin, so gloves are a necessity for most people using solvent-based adhesive removers.

Many of the above solvents are toxic, and so are unsuitable for use by children or in the home.

Finally, solvents can damage paint, plastics, rubber, or surface finishes.

There is a long-felt need for an adhesive remover that does not have the above disadvantages. An adhesive remover that is water-based, nontoxic, harmless to painted surfaces or surface finishes, and that completely removes all traces of goo would be a substantial improvement in the art.

### SUMMARY

The present invention provides a cleaning composition for removing adhesives, goo substances and pine sap. The cleaning composition is water-based.

The cleaning composition can comprise 20-75% water, up to 25% water-soluble surfactant, and 15-80% multi-valent metal fatty acid powder. The multi-valent metal fatty acid powder I wetted by the water and surfactant. The multi-valent metal fatty acid powder can be magnesium stearate or calcium stearate for example. The multi-valent metal can be calcium, magnesium, zinc or aluminum.

The cleaning composition can comprise 20-70% or 25-65% multi-valent metal fatty acid soap. The surfactant can be any surfactant that wets the multi-valent metal fatty acid soap. The surfactant can be decyl glucoside, lauryl glucoside, capryl glucoside, octyl glucoside, coco glucosise, nonionic glucoside surfactants, fatty acid-glucoside surfactants, cocamidopropyl betaine, lauramine oxide, sodium lauryl sulfoacetate, alkyl polyglucoside, sucrose cocoate, alkali metal fatty acid soaps, and mono-glyceride.

The cleaning composition can also consist essentially of 15-80% multi-valent metal soap powder, at least 0.5% surfactant, at least 15% water, and up to 40% abrasive powder.

### DETAILED DESCRIPTION

The present invention provides a water-based cleaner for removing goo substances such as adhesives and pine sap. The present cleaner comprises a multi-valent metal fatty acid (MVMFA) soap wetted with water and surfactant. The multi-valent metal fatty acid soap can be magnesium stearate for example. The surfactant can be decyl glucoside for example. The MVMFA soap is made of particles and is not soluble in water. The surfactant is effective for wetting the MVMFA soap particles with water, but does not dissolve the MVMFA particles. The present inventor has discovered that a MVMFA soap wetted with water is effective for removing adhesives and pine sap, particularly if the MVMFA soap is present in concentration exceeding about 10%, 15% or 20% by weight, and if the adhesive is scrubbed. The present cleaner may also include particles of an abrasive material such as glass powder, calcium carbonate powder, or rock powder.

### Definitions

Multi-valent metal: A metal with a preference to acquire a +2 or higher valence state in a chemical compound. This includes all metals except for the alkali metals of group 1 (lithium, sodium, potassium, rubidium, and cesium). Multi-valent metals particularly useful in the present invention include magnesium, calcium, aluminum, zinc, and iron. The multi-valent metal in the present invention may have a charge of +2 or +3.

Soap: In the present application, “soap” always refers to a multi-valent metal fatty acid soap. For brevity, the acronym “MVMFA” may be omitted. The term “soap” as used herein does not include alkali metal soaps (i.e. metal fatty acid soaps made with lithium, sodium, potassium, rubidium or cesium, such as sodium stearate).

All recipe percentages in the present application are by weight.

The present invention provides a water-based cleaner for removing goo substances. The present cleaner does not rely on solvents and does not produce flammable or toxic vapors. The present cleaner has microscopic particles of multi-valent (for example, metal is in +2 or +3 valance state) metal fatty acid soap mixed in water with a surfactant. Optionally, the cleaner also contains a abrasive powder. The metal soap can comprise magnesium stearate, zinc stearate, aluminum stearate or calcium stearate, or mixtures thereof for example. Other fatty acids (having 8-22 carbon atoms for example) can be used instead of stearate (which has 18 carbon atoms).

The MVMFA soap in the present invention has low water solubility. For example, magnesium stearate has a water solubility of about 30 mg/liter. In the present invention the MVMFA soap has water solubility of less than 100, 250 or 500 mg/liter. In the present invention, the MVMFA soap must be present as solid particles, not as a water-based solution.

The MVMFA soap particles are dispersed in water containing a dissolved surfactant. Preferably, the surfactant is a nonionic surfactant, but this is optional in the invention. The surfactant can be decyl glucoside, coco glucoside, octyl glucosise, sodium lauryl sulfoacetate. lauryl glucoside, capryl glucoside, lauramine oxide, cocamidopropyl betaine, or mono-glyceride, sodium stearate, or mixtures thereof for example. The present invention and claims are not limited to any particular group or subset of surfactants. Any surfactant that causes wetting of the MVMFA particles by water can be used in the invention. The surfactant can be nonionic, ionic, or amphoteric. In a preferred embodiment of the invention, the surfactant is a fatty acid glucoside. Fatty acid glucoside surfactants have very low toxicity and perform well at wetting MVMFA soaps.

A specific embodiment of the invention contains the following percentages by weight:
Water: 52.3%
Mg Stearate: 42.8%
Decyl glucoside: 4.7%

The present goo remover according to the above recipe is made by first heating the water to about 120-160 degrees Fahrenheit, and then adding some or all of the decyl glucoside to the water. The decyl glucoside is stirred to dissolve it in the warm water. The decyl glucoside tends to cause foaming if all of it is added to the water at the beginning. Hence, it is best to add about 25%-50% of the decyl glucoside initially, and then add the rest slowly in parallel with the magnesium stearate. The magnesium stearate is added slowly while mixing. The mixture will thicken as magnesium stearate is added. While the mixture is still warm, it will have a soft, barely-pourable consistency. As it cools to room temperature, it will harden to form a semi-solid material that cannot be poured. A suitable temperature for pumping and packaging is about 120-135 F.

The magnesium stearate prior to mixing is a powder, and can have an average particle size of about 10 microns. The MVMFA powder can have particles sizes in the range of about 1-100, 2-50 or 5-25 microns. The particle size of the as-added magnesium stearate is not critical.

It is noted that some of the magnesium stearate particles break apart into thin splinters or fibers during mixing and/or subsequent storage. The Mg stearate splinters can have aspect ratios of about 5, 10 or 15. The present application is not limited to any specific theory of operation regarding the particle size or morphology of the Mg stearate particles, but it is believed that the elongated splinter-shape of the Mg stearate particles may improve the performance of the present goo remover. The present application and scope of the present claims are not limited to embodiments with high aspect ratio Mg stearate particles.

The cleaning composition can comprise at least about 15%, 20%, 25% or 30% v by weight MVMFA powder.

Alkali metal fatty acid soaps such as sodium stearate or potassium stearate can be used as the surfactant.

The surfactant can comprise less than about 10%, 8%, 5% or 3% by weight. The surfactant is required in the invention because it is necessary to wet the MVMFA powder. The surfactant cannot be omitted.

The present application is not limited to a specific mechanism of action, because it is not known for certain how the present cleaner works. However, it appears that the cleaner works because the MVMFA powder adheres to hydrophobic goo. By covering the goo, the MVMFA soap particles cover the goo surface, and thereby neutralizes its ability to adhere to any other substance. The present cleaner, when used to scrub some types of acrylic or rubber adhesives, tends to cause the adhesive to form non-sticky, non-adherent, macroscopic balls and cylinders. So, the present cleaner appears to remove some types of adhesive by a “pilling” phenomenon.

The present cleaner does not dissolve the goo. The present cleaner does not dissolve acrylic adhesive, rubber adhesive, pine sap or any other goo substances. The goo sticks to the MVMFA particles thereby inhibiting redeposition or smearing of the goo.

The present cleaner can also include an abrasive powder such as glass powder, soda lime glass powder, limestone powder, mica powder, walnut shell powder, ceramic powder, aluminum oxide powder, silicon carbide powder, clay, and aluminosilicate powder. The abrasive powder can have an average particle size of about 5-1000 microns, or 10-100 microns. The abrasive powder can have sizes of about about 60-400 mesh. In a specific embodiment, the abrasive powder is 325 mesh soda lime glass powder. The abrasive powder can also be made of sodium bicarbonate. In this embodiment, the amount of sodium bicarbonate must exceed the water solubility limit (about 100 grams/liter), so that solid particles of sodium bicarbonate are present.

Below is a recipe containing abrasive powder according to the present invention.
Water: 43%
Mg stearate: 32%
Decyl glucoside: 7.5%
Glass powder (325 mesh): 17%

In an aspect of the invention, the MVMFA powder, abrasive powder, and surfactant are sold as a mixture (without water) to the end user. The user adds a desired amount of water to the mixture and blends. Therefore, in this case the end user adjusts the amount of water added to achieve a desired viscosity.

The present cleaner may also contain, colorants, fragrances, or preservatives as known in the art.

What is claimed is:

1. A cleaning composition consisting essentially of:
a) 20-85% water;
b) 15-80% multi-valent metal fatty acid soap particles; and
c) surfactant in quantity sufficient to wet the multi-valent metal fatty acid soap particles.

2. The cleaning composition of claim 1, wherein the multi-valent metal is calcium, magnesium, zinc or aluminum.

3. The cleaning composition of claim 1 containing 20-70% multi-valent metal fatty acid soap particles.

4. The cleaning composition of claim 1 containing 25-65% multi-valent metal fatty acid soap particles.

5. The cleaning composition of claim 1 containing 0.5-20% surfactant.

6. The cleaning composition of claim 1 wherein the surfactant is selected from the group consisting of decyl glucoside, lauryl glucoside, capryl glucoside, octyl glucoside, coco glucoside, nonionic glucoside surfactants, fatty acid-glucoside surfactants, cocamidopropyl betaine, lauramine oxide, sodium lauryl sulfoacetate, alkyl polyglucoside, sucrose cocoate, alkali metal fatty acid soaps, and mono-glyceride.

7. The cleaning composition of claim 1 wherein the surfactant is a nonionic surfactant.

8. A cleaning composition consisting essentially of:
a) 20-75% water;
b) 15-65% multi-valent metal fatty acid soap particles; and
c) surfactant in quantity sufficient to wet the multi-valent metal fatty acid soap particles.
d) up to 40% abrasive powder.

9. The cleaning composition of claim 8 wherein the abrasive powder is selected from the group consisting of glass powder, soda lime glass powder, limestone powder, mica powder, walnut shell powder, ceramic powder, aluminum oxide powder, silicon carbide powder, clay, sodium bicarbonate powder, and aluminosilicate powder.

10. The cleaning composition of claim 8 wherein the abrasive powder is glass powder.

11. The cleaning composition of claim wherein the abrasive powder has an average particle size in the range of 10-250 microns.

12. The cleaning composition of claim 8 containing 0.5-10% surfactant.

13. The cleaning composition of claim 8 wherein the surfactant is selected from the group consisting of decyl glucoside, lauryl glucoside, capryl glucoside, octyl glucoside, coco glucosise, nonionic glucoside surfactants, fatty acid-glucoside surfactants, cocamidopropyl betaine, lauramine oxide, sodium lauryl sulfoacetate, alkyl polyglucoside, sucrose cocoate, alkali metal fatty acid soaps, and mono-glyceride.

14. The cleaning composition of claim 8 wherein the surfactant is a nonionic surfactant.

15. A cleaning composition consisting essentially of:
a) 15-80% multi-valent metal soap powder;
b) at least 0.5% surfactant, wherein the surfactant is wets the multi-valent metal soap powder;
c) at least 15% water
d) up to 40% abrasive powder;

16. The cleaning composition of claim 15 containing 1-10% surfactant.

17. The cleaning composition of claim 15 wherein the surfactant is selected from the group consisting of decyl glucoside, lauryl glucoside, capryl glucoside, octyl glucoside, coco glucosise, nonionic glucoside surfactants, fatty acid-glucoside surfactants, cocamidopropyl betaine, lauramine oxide, sodium lauryl sulfoacetate, alkyl polyglucoside, sucrose cocoate, alkali metal fatty acid soaps, and mono-glyceride.

18. The cleaning composition of claim 15 wherein the surfactant is a nonionic surfactant.
